(19) United States
(12) Patent Application Publication
(10) Pub. No.: US 2008/0016144 A1
(43) Pub. Date: Jan. 17, 2008

(54) Method for providing information service and push mode service

(75) Inventors: Lyun-sik Hyun, Suwon-si (KR); Hee-young Lee, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/493,599

(22) Filed: Jul. 27, 2006

(30) Foreign Application Priority Data
Aug. 17, 2005 (KR) 10-2005-0075252

(51) Int. Cl. G06F 15/16

(52) U.S. Cl. 709/203

(57) ABSTRACT

A method of providing information and a method of providing a push mode service. The method includes: obtaining from a client a priority in relation to a service mode desired by the client, determining whether or not a push mode service is to be provided continuously according to priority, and providing a service according to the determination. While a service is used in a pull mode, according to the priority selected by the client, reception of a push mode service is refused or the pull mode service is stopped and switched to a push mode so that important information can be received.

### CROSS-REFERENCE TO RELATED PATENT APPLICATIONS

This application claims priority from Korean Patent Application No. 10-2005-0075252, filed on Aug. 17, 2005, in the Korean Intellectual Property Office, the entire disclosure of which is incorporated herein by reference.

### BACKGROUND OF THE INVENTION

1. Field of the Invention

Methods consistent with the present invention relate to providing information and providing a push mode service, and more particularly, to a method by which a client can selectively receive a push mode service or a pull mode service by using priority in a push and pull mode multimedia service between a server and the client connected to each other through a network.

2. Description of the Related Art

A pull mode means a mode by which a client actively requests a server to provide information and receives the service. An example of the pull mode is a case where a client requests a song list from a server providing music, requests a particular song from the song list, and receives the corresponding song content. Meanwhile, a push mode means a mode by which a server compulsorily distributes information to a client. An example of the push mode is a case where a network-connected monitor installed in a waiting room of a train station or a bus terminal displays information on departure times of trains or buses and advertisements transmitted by a server. Also, a wake on LAN (WOL) service enabling a type of remote control of computers can be said to be included in push mode services. In the WOL service, medium access control (MAC) address information of a network card is multicast over a LAN so that the power is turned on for the computer in which the network card with the corresponding MAC address is installed. Meanwhile, even in the Internet environment where pull mode services historically have been predominant, the number of servers providing push mode services has been increasing.

The conventional multimedia service protocol for providing both push mode services and pull mode services in a server/client structure connected through a network includes a function by which a client is registered with a server as a service receiver and service is provided, a pull mode service function controlled by a client, a push mode service function controlled by a server, a function whereby a server remotely controls a client, and a function to terminate a service between a server and a client.

However, because the conventional technology lacks a control function to switch between a pull mode service and a push mode service, if a push mode service begins, even though a user is working in a pull mode, the pull mode service is compulsorily stopped, causing inconvenience to the user. Accordingly, the control function capable of appropriately controlling according to the characteristics of an application system is needed.

### SUMMARY OF THE INVENTION

Exemplary embodiments of the present invention may overcome the above disadvantages and other disadvantages not described above. The present invention is not necessarily required to overcome any of the disadvantages described above, and the exemplary embodiments of the present invention may not overcome any of the problems described above. The appended claims should be consulted to ascertain the true scope of the invention.

The present invention provides an information providing method and a push mode service providing method by which a client can select a priority of a service mode in a system supporting both a push mode service and a pull mode service.

The present invention also provides an information providing method and a push mode service providing method by which a mode priority is requested from the client when a push mode service begins while a user is engaged in a pull mode service between a client and a server, and according to the answer of the client, a service providing mode is determined.

According to an aspect of the present invention, there is provided a method of providing information from a server to a client, including: obtaining from the client an information providing mode selected by the client and providing information to the client according to the information providing mode.

The obtaining from the client an information providing mode may include: requesting the information providing mode from the client and receiving the information providing mode from the client in response to the request.

The information providing mode may be any one of a “pull-mode-first” mode giving priority to the pull mode service, a “push-mode-first” mode giving priority to the push mode service, and a “user-selection-first” mode in which the information providing mode is determined by a user's selection.

According to another aspect of the present invention, there is provided a push mode service providing method including: obtaining from the client a priority in relation to the service mode desired by the client, determining whether or not to continue to provide the push mode service according to the priority obtained from the client, and providing a service according to the determination.

The obtaining of the priority may include: requesting the priority from the client and receiving the priority from the client in response to the request.

In the providing of the service, if the priority is the “pull-mode-first” mode giving priority to the pull mode service, the push mode service may be stopped. If the priority is the “push-mode-first” mode giving priority to the push mode service, the push mode service may be continuously provided.

In the providing of the service, if the priority is the “user-selection-first” mode in which the information providing mode is determined by the user's selection, the push mode service may be stopped or continued according to the user's selection received from the client.

According to still another aspect of the present invention, there is provided a push mode service providing method for remote control, including: obtaining from a client a priority in relation to a service mode desired by the client; stopping the remote control if the priority is the “pull-mode-first” mode giving priority to the pull mode service; transmitting a remote control command to the client and receiving the result of the execution of the remote control command from the client if the priority is the “push-mode-first” mode giving priority to the push mode service; and transmitting a remote control command to the client if the priority is the “user-selection-first” mode in which a service mode is determined by the user's selection, then stopping the remote control if the user's selection is the “pull mode” and receiving the result of the execution of the remote control command from the client if the user's selection is the “push mode.”

### BRIEF DESCRIPTION OF THE DRAWINGS

The above and other aspects of the present invention will become more apparent from the following description of exemplary embodiments thereof with reference to the accompanying drawings, in which:

FIG. 1 illustrates an example of a process for registering at a server in order to use a push and pull mode service according to an exemplary embodiment of the present invention;

FIG. 2 illustrates an example of a process for transmitting and receiving messages for a pull mode service according to an exemplary embodiment of the present invention;

FIG. 3 is a flowchart of a mechanism for providing a push mode service by a push mode service providing method according to an exemplary embodiment of the present invention;

FIG. 4A illustrates an example of a process for transmitting and receiving messages when priority information indicates a “pull-mode-first” mode in a push mode service according to an exemplary embodiment of the present invention;

FIG. 4B illustrates an example of a process for transmitting and receiving messages when priority information indicates a “push-mode-first” mode in a push mode service according to an exemplary embodiment of the present invention;

FIGS. 4C and 4D illustrate an example of a process for transmitting and receiving messages according to a selection of a user when priority information indicates a “user-selection-first” mode in a push mode service according to an exemplary embodiment of the present invention;

FIG. 5 is a flowchart of a mechanism for providing a remote control service by a push mode service providing method according to an exemplary embodiment of the present invention;

FIG. 6A illustrates an example of a process for transmitting and receiving messages when priority information indicates a “pull-mode-first” mode in a remote control service according to an exemplary embodiment of the present invention;

FIG. 6B illustrates an example of a process for transmitting and receiving messages when priority information indicates a “push-mode-first” mode in a remote control service according to an exemplary embodiment of the present invention;

FIGS. 6C and 6D illustrate an example of a process for transmitting and receiving messages according to a selection of a user when priority information indicates a “user-selection-first” mode in a remote control service according to an exemplary embodiment of the present invention; and

FIGS. 7A and 7B illustrate an example of a process for transmitting and receiving a message to finish a push and pull mode service according to an exemplary embodiment of the present invention.

### DETAILED DESCRIPTION OF THE EXEMPLARY EMBODIMENTS

Certain exemplary embodiments of the present invention will now be described more fully with reference to the accompanying drawings.

According to an exemplary embodiment of the present invention, messages to be used to implement a protocol are passed in the form of packets having a predefined structure when the messages are transmitted through a network, but in the present specification, an example of each message structure will be suggested by describing only fields to be included in the payload of a packet.

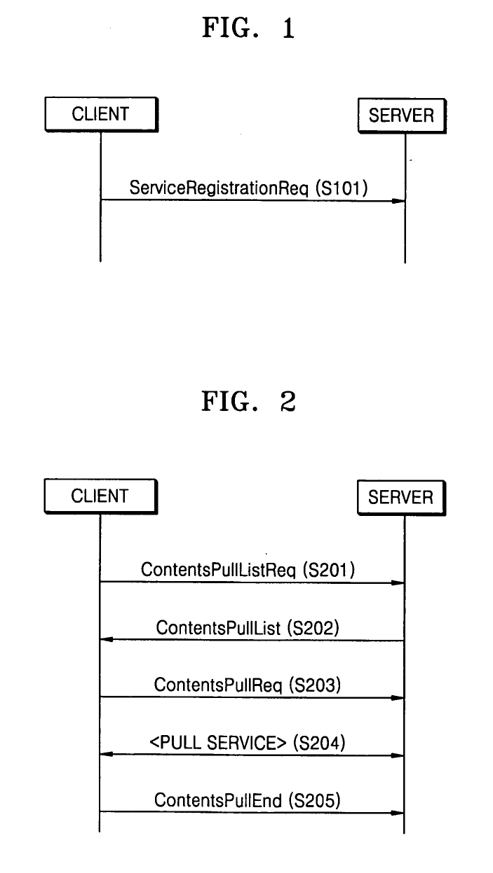

FIG. 1 illustrates an example of a process for registering at a server in order to use a push and pull mode service according to an exemplary embodiment of the present invention.

The process begins when a client that desires to use the service of the server sets information on the client itself and the type of service in a “service registration” message (ServiceRegistrationReq), and transmits the message to the server in operation S101. If the server provides the same service type specified by ServiceRegistrationReq, the server registers the client, and by using the ServiceRegistrationReq information, the server can manage clients by group. For example, clients are divided into groups; rights for each group are set; and contents can be provided only to clients belonging to a group having a right to receive contents. By doing so, rights management by group is enabled.

Meanwhile, the ServiceRegistrationReq can be transmitted through a socket for controlling service start and end and for controlling multimedia service. This uses TCP mode separately from a data transmission channel.

ServiceRegistrationReq Packet payload={MAC address, service type, group name, client name}

Here, the “MAC address” is a unique identification number of a network card and is used as an identifier to distinguish each client. The “service type” is a unique identifier (ID) to distinguish a variety of services provided by the server. The “group name” is a name used when clients are divided into a plurality of groups and managed. The “client name” is used to distinguish each client and as a user-friendly alias. The purposes of fields to be explained in the present specification are applied identically throughout the specification.

FIG. 2 illustrates an example of a process for transmitting and receiving messages for a pull mode service according to an exemplary embodiment of the present invention. A client can use a push mode or a pull mode service. In the pull mode service, the client actively requests content desired by the client, from the multimedia content of a server, and receives the requested content.

As shown in FIG. 2, if the client specifies a desired “medium type” and requests a content list in operation S201, the server confirms whether the requested service type is the same as provided by the server and the right of the client and then generates and transmits the contents list of a corresponding medium in operation S202. If the client specifies and requests desired “contents information” in this contents list in operation S203, the server confirms the service type and client right and then begins to transmit the contents in operation S204. The pull mode service is finished by the client asking for termination of the service in operation S205.

The exemplary structures of messages used to provide the pull mode service as described above are as follows:

ContentsPullListReq Packet payload={service type, group name, client name, medium type, list sort information, list request information}

ContentsPullList Packet payload={service type, server name, medium type, contents list information, server service network information}

ContentsPullReq Packet payload={service type, group name, client name, contents information}

ContentsPullEnd Packet payload={service type, group name, client name, medium type}

Here, the “medium type” is used to distinguish a variety of media and includes, for example, movie, music, photo, document, and the like. The “list sort information” is to specify how the contents list is sorted and received, and includes, for example, file name, date, size, genre, etc. The “list request information” is a field to specify the number of lists per page, the position of a page, etc. The “contents list information” is the list of contents corresponding to the “medium type” requested by the client among the contents provided by the sever. Also, the “server service network information” is access information of a network through which the server provides services and includes an IP address and port number, and when multicast is required depending on the type of services, may also include a multicast IP address and port number. The “contents information” is information on respective contents, and a file name, size, generated date, play time, and thumbnail can be specified.

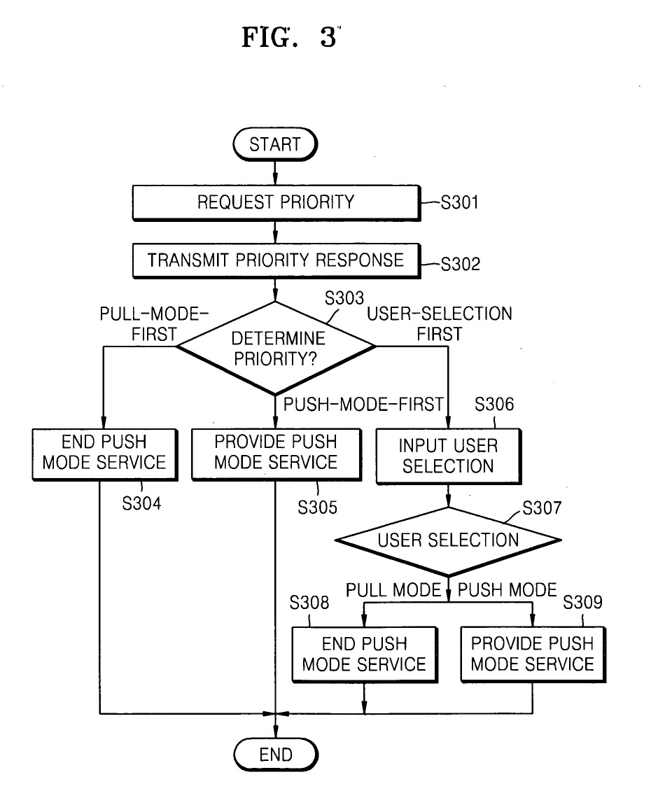

FIG. 3 is a flowchart of a mechanism for providing a push mode service by a push mode service providing method according to an exemplary embodiment of the present invention. This embodiment shows a case where a server pushes multimedia data and other information to a client, and can be said to be a most basic example of a push mode service.

When a server transmits data in a push mode in the conventional push and pull mode service, the service begins by a one-sided compulsory transmission of a contents list to a client by the server. However, in an exemplary embodiment of the present invention, when the server begins a push mode service, a priority is requested in order to determine which mode of service the client wants to receive preferentially in operation S301. The client, receiving a priority question, transmits a response message including a desired priority in operation S302. Though the priority information of the client is requested and received when the push mode service begins in the shown exemplary embodiment, the client may actively transmit priority information whenever the status of the client changes, and the server may use the information in order to determine whether or not to provide a push mode service. Meanwhile, in the present embodiment, “pull-mode-first,” “push-mode-first,” and “user-selection-first” are suggested as priorities that the client can select, but the priorities are not limited to these.

It is determined whether the priority received from the client is “pull-mode-first” mode, “push-mode-first” mode or “user-selection-first” mode in operation S303. If it is the “pull-mode-first” mode, the push mode service is terminated and switched to a pull mode in operation S304. Meanwhile, if it is the “push-mode-first” mode, the push mode service is continued to provide the data push service in operation S305. At this time, if the client is using the pull mode service, the pull mode service will be terminated.

Meanwhile, if the priority is the “user-selection-first” mode, the client needs to receive priority information from the user in operation S306. This can be implemented in a variety of ways. Examples of the implementation include direct input by the user or user's selection in a set file.

Whether or not to continue the push mode service is determined by the user selection in operation S307. If the user selects the “pull mode,” the push mode service is terminated and switched to the pull mode in operation S308. Meanwhile, if the user selects the “push mode,” the push mode service is continued in operation S309.

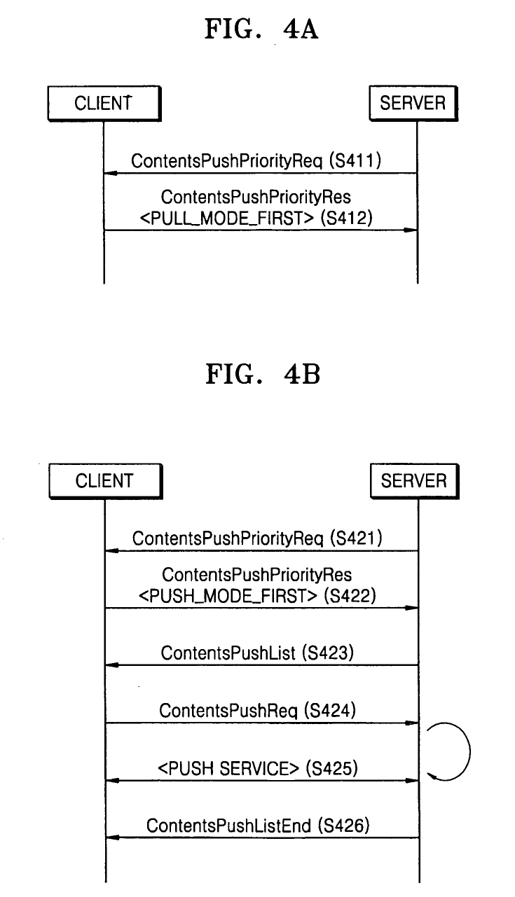

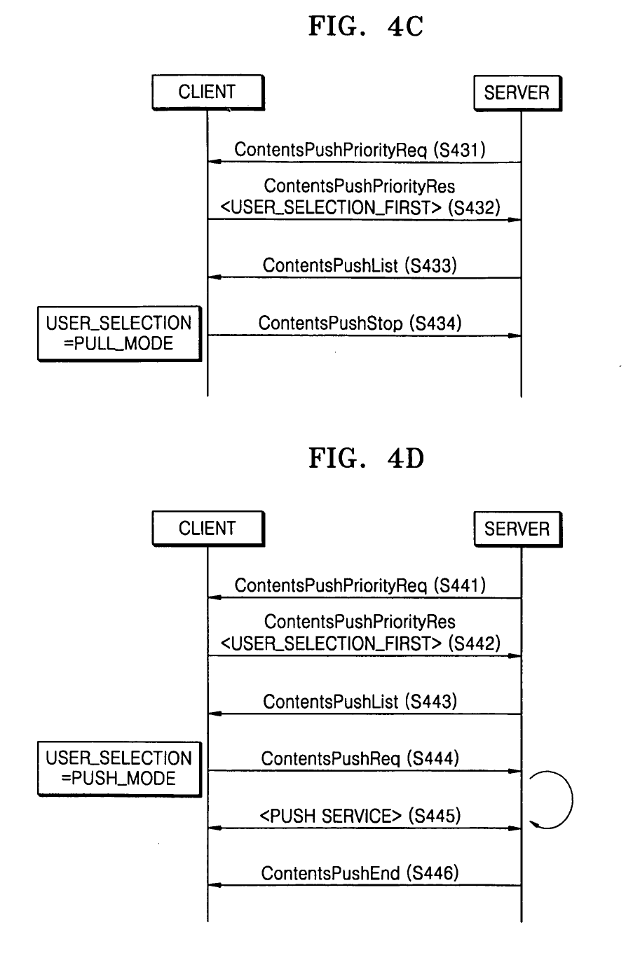

Hereinafter, an exemplary embodiment to provide the data push service will be explained in more detail with reference to message transmission and reception protocols shown in FIGS. 4A through 4D.

FIG. 4A illustrates an example of a process for transmitting and receiving a message when priority information indicates a “pull-mode-first” mode in a push mode service according to an exemplary embodiment of the present invention. First, if a server transmits a “contents push priority request” message (ContentsPushPriorityReq) to a client to which the server is to provide a push service in operation S411, the client transmits a “contents push priority response” message (ContentsPushPriorityRes), including “priority information,” as a response in operation S412. The example of the structure of each message will be explained later.

If the priority of the client is the “pull-mode-first (PULL_MODE_FIRST)” mode as in FIG. 4A in operation S412, the server stops providing the push mode service further. In this case, the client can continue to use the pull mode service without interference of the push mode service.

FIG. 4B illustrates an example of a process for transmitting and receiving messages when priority information indicates a “push-mode-first” mode in a push mode service according to an exemplary embodiment of the present invention. This is a case where the “priority information” of the ContentsPushPriorityReq received by the server is set to the “push-mode-first (PUSH_MODE_FIRST)” mode in operations S421 and S422.

In this case, the server transmits a “contents push list” message (ContentsPushList) in operation S423. The ContentsPushList includes “contents list information” which is a list of contents that the server desires to push, and by referring to this list, the client transmits a “contents push request” message (ContentsPushReq) to request the server to push the contents in operation S424. In response to this request, the server confirms the “service type” and the right of the client and then provides the push service for the requested contents in operation S425. That is, by transmitting the ContentsPushReq, the client sequentially requests the contents in the contents list, and receives contents from the server, and this process is repeated to the end of the contents list.

If the push service for all contents is finished, the server transmits a “contents push end” message (ContentsPushEnd) to end the push mode service in operation S426.

FIGS. 4C and 4D illustrate an example of a process for transmitting and receiving messages according to the selection of a user when priority information indicates a “user-selection-first” mode in a push mode service according to an exemplary embodiment of the present invention. Here, the “priority information” in the ContentsPushPriorityRes received from the client is set to the “user-selection-first” mode (USER_SELECTION_FIRST) in operations S431, S432, S441, and S442. In this case, the server transmits the ContentsPushList in operations S433 and S443.

If the response of the user is the “pull mode” as in FIG. 4C, the client transmits a “contents push stop” message (ContentsPushStop) in operation S434, and the server receiving the message stops providing further the push mode service. Accordingly, the client can continue to use the pull mode service without interference from the push mode service.

If the response of the user is the “push mode” as in FIG. 4D, the push mode service continues and then ends, as described with reference to FIG. 4B, in operations S444 through S446.

Examples of the structures of messages used in the present embodiment of the present invention described above with reference to FIGS. 4A through 4D are as follows:

ContentsPushPriorityReq Packet payload={service type, server name, server service network information}

ContentsPushPriorityRes Packet payload={service type, group name, client name, priority information}

ContentsPushList Packet payload={service type, server name, medium type, contents list information, server service network information}

ContentsPushReq Packet payload={service type, group name, client name, contents information}

ContentsPushStop Packet payload={service type, group name, client name, error information}

ContentsPushEnd Packet payload={service type, server name, medium type}

As described above, the “priority information” of the ContentsPushPriorityRes is set to “PUSH_MODE_FIRST,” “PULL_MODE_FIRST,” or “USER_SELECTION_FIRST.”

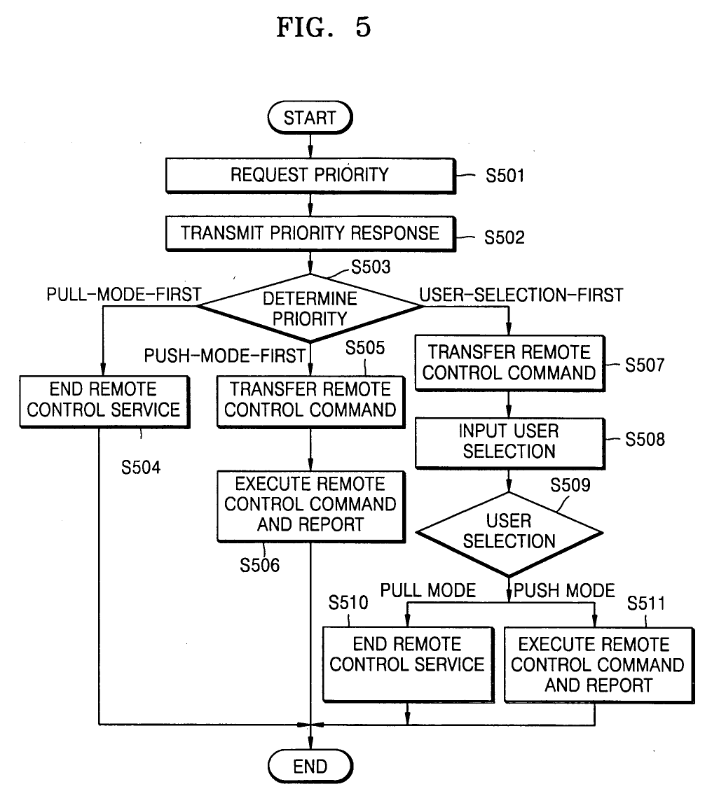

FIG. 5 is a flowchart of a mechanism for providing a remote control service by a push mode service providing method according to an exemplary embodiment of the present invention. The remote control service is a service to remotely control the power status of a client, the screen, a sound mode, etc. , and monitor the status of the client.

When a push mode service for the remote control service begins, a server asks the priority of a client in operations S501 and S502, and according to the priority, determines whether to continue the remote control service in operation S503. Depending on an application system, it can be determined whether to begin the remote control service by using priority information provided in advance by the client.

If the priority information from the client is a “pull-mode-first” mode, the remote control service is terminated in operation S504, otherwise, a remote control command from the server is transmitted to the client in operations S505 and S507. If the priority information is the “pull-mode-first” mode, the pull mode service can be continuously used without interference from the remote control service, and if it is the “push-mode-first” mode, the transmitted remote control command is executed and then the result is reported to the server in operation S506.

Meanwhile, if the priority information is a “user-selection-first” mode, the client receives an input of a priority from the user in operation S508. If the user's selection is the “pull mode,” the remote control service is terminated in operations S509 and S510, and if it is the “push mode,” the received remote control command is executed and the result is reported in operations S509 and S511.

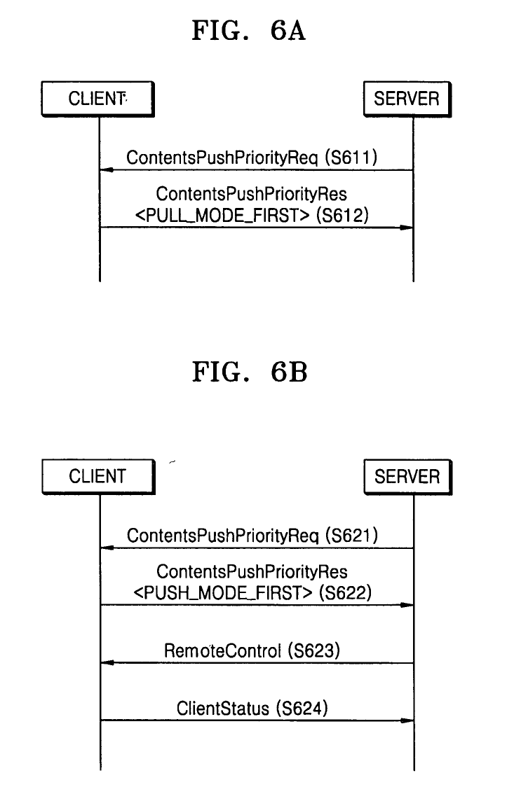

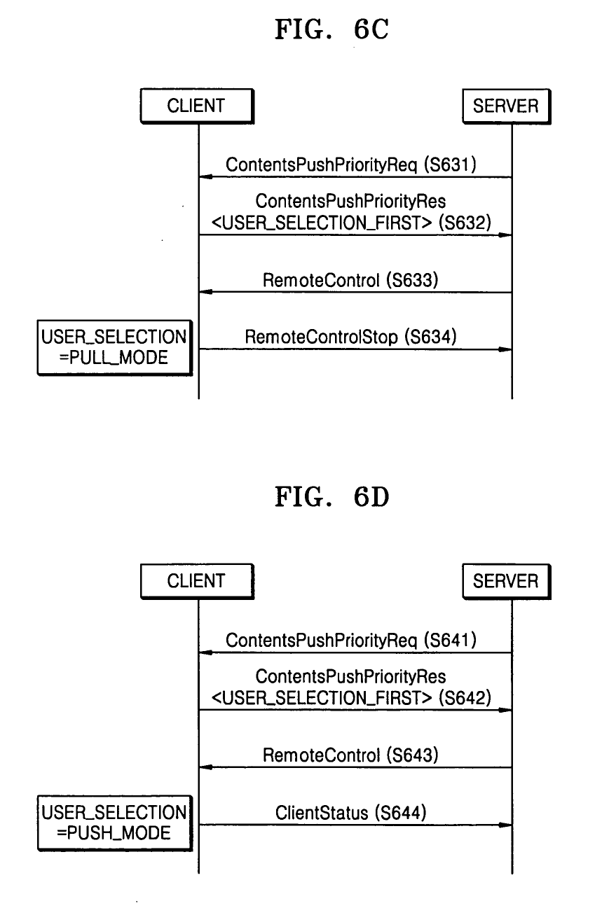

Hereinafter, the embodiment for the remote control service will be explained in more detail with reference to message transmission and reception protocols shown in FIGS. 6A through 6D.

FIG. 6A illustrates an example of a process for transmitting and receiving messages when priority information indicates a “pull-mode-first” mode in a remote control service according to an exemplary embodiment of the present invention, and FIG. 6B illustrates an example of a process for transmitting and receiving a message when priority information indicates a “push-mode-first” mode.

First, the server transmits ContentsPushPriorityReq to confirm the priority of a client desired to be remote controlled in operations S611 and S621, and in response, the client transmits ContentsPushPrioirtyRes in operations S612 and S622.

If the “priority information” of the ContentsPushPriorityRes is “PULL_MODE_FIRST” as shown in FIG. 6A, the sever stops the remote control service, and the client can continue to use the pull mode service without interference from the remote control by the server.

Meanwhile, if the priority information is “PUSH_MODE_FIRST” as shown in FIG. 6B, the server transmits a “remote control” message (RemoteControl) in operation S623. By referring to a “remote control command” and a “remote control command parameter” included in the RemoteControl, the client executes the corresponding command, and then, loads the status information of the client on a “client status” message (ClientStatus), and transmits the message to the server in operation S624.

FIGS. 6C and 6D illustrate an example of a process for transmitting and receiving a message according to a selection of a user when priority information indicates a “user-selection-first” mode in a remote control service according to an exemplary embodiment of the present invention. Here, the “priority information” of ContentsPushPriorityRes received by the server is set to “USER_SELECTION_FIRST” in operations S631, S632, S641, and S642, and RemoteControl is transmitted by the server in operations S633 and S643.

If the response of the user is “PULL_MODE” as shown in FIG. 6C, the client transmits a “remote control stop” message (RemoteControlStop) in operation S634, and the server receiving this message stops the remote control service. If the response of the user is “PUSH_MODE” as shown in FIG. 6D, the client executes a remote control command according to the RemoteControl from the server, and reports its status in operations S643 and S644.

The examples of the structures of messages used in the embodiment of the present invention described above with reference to FIGS. 6A through 6D are as follows:

RemoteControl Packet payload={service type, server name, remote control command, remote control command parameter}

ClientStatus Packet payload={service type, server name, client status information}

RemoteControlStop Packet payload={service type, server name, client status information, error information}

Here, the “remote control command” is a command which is desired to be executed in the client through remote control by the server, and can include a variety of commands, such as changing power status to off, WOL, adjustment of brightness, color, illumination, volume, screen mode, and sound. The “remote control command parameter” is parameter information required for executing the “remote control command.”

Meanwhile, the “client status information” and “error information” are fields to report the result of executing the remote control command. The “client status information” can include status information in relation to the brightness, color, illumination, volume, screen mode, sound mode, corresponding to the executed remote control command.

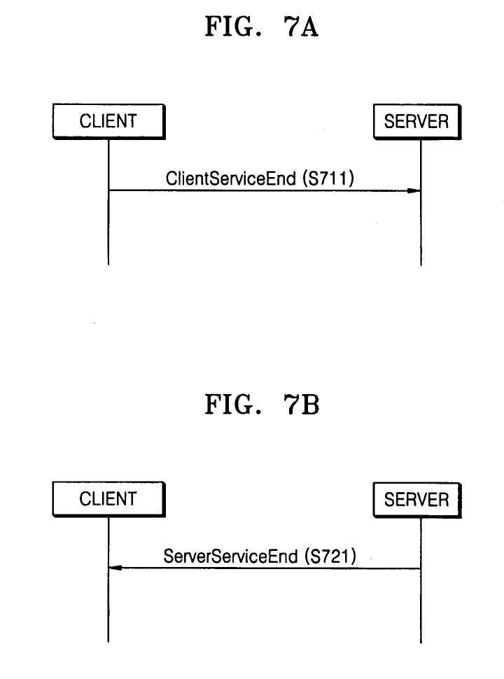

FIGS. 7A and 7B illustrate an example of a process for transmitting and receiving a message to finish a push and pull mode service according to an exemplary embodiment of the present invention. FIG. 7A shows a case where, in operation S711, a client loads information on the client on a “client server end” message (ClientServiceEnd) requesting to end access to a server, and transmits the message, and by doing so, the service is terminated. FIG. 7B shows a case where when a server system is to end, the server transmits a “server service end” message (ServerServiceEnd) to all clients in operation S721 so that the service is finished.

The examples of the structures of messages used in the termination of services are as follows:

ClientServiceEnd Packet payload={MAC address, service type, group name, client name}

ServerServiceEnd Packet payload={service type, server name}

Meanwhile, a server or a client can sense an abnormal termination by the other side by periodically transmitting a “connection confirmation” message (ConnectionConfirm).

ConnectionConfirm Packet payload={MAC address, service type, group name, client name}

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in a descriptive sense only and not for purposes of limitation. Therefore, the scope of the invention is defined not by the detailed description of the invention but by the appended claims and their equivalents, and all differences within the scope will be construed as being included in the present invention.

According to the structure of an exemplary embodiment of the present invention as described above, while a service is used in a pull mode, according to the priority selected by the client, reception of a push mode service is refused or the pull mode service is stopped and switched to a push mode so that important information can be received. Also, according to an exemplary embodiment of the present invention, a service mode can be selected according to the response of the user, and therefore according to the decision of the user, an important service between the pull mode service and push mode service may be received.

What is claimed is:

1. A method of providing information from a server to a client, the method comprising:
obtaining from the client an information providing mode selected by the client; and
providing information to the client according to the obtained information providing mode.

2. The method of claim 1, wherein the obtaining of the information providing mode comprises:
requesting the information providing mode from the client; and
receiving the information providing mode from the client in response to the request.

3. The method of claim 2, wherein the information providing mode is one of: a “pull-mode-first” mode giving priority to a pull mode service, a “push-mode-first” mode giving priority to a push mode service, and a “user-selection-first” mode in which the information providing mode is determined by a user selection.

4. A push mode service providing method comprising:
obtaining from a client a priority in relation to a service mode selected by the client;
determining whether to continue to provide a push mode service according to the obtained priority; and
providing a service according to a result of the determining.

5. The method of claim 4, wherein the obtaining of the priority comprises:
requesting the priority from the client; and
receiving the priority from the client in response to the request.

6. The method of claim 4, wherein in the providing of the service, if the priority is a “pull-mode-first” mode giving priority to a pull mode service, the push mode service is stopped, and if the priority is a “push-mode-first” mode giving priority to the push mode service, the push mode service is continuously provided.

7. The method of claim 5, wherein in the providing of the service, if the priority is a “pull-mode-first” mode giving priority to a pull mode service, the push mode service is stopped, and if the priority is a “push-mode-first” mode giving priority to the push mode service, the push mode service is continuously provided.

8. The method of claim 4, wherein in the providing of the service, if the priority is a “user-selection-first” mode in which the information providing mode is determined by a user selection, the push mode service is stopped or continued according to the user selection received from the client.

9. The method of claim 5, wherein in the providing of the service, if the priority is a “user-selection-first” mode in which the information providing mode is determined by a user selection, the push mode service is stopped or continued according to the user selection received from the client.

10. The method of claim 6, wherein in the providing of the service, if the priority is a “user-selection-first” mode in which the information providing mode is determined by a user selection, the push mode service is stopped or continued according to the user selection received from the client.

11. The method of claim 7, wherein in the providing of the service, if the priority is a “user-selection-first” mode in which the information providing mode is determined by a user selection, the push mode service is stopped or continued according to the user selection received from the client.

12. A push mode service providing method, comprising:
obtaining from a client a priority in relation to a service mode selected by the client;
if the obtained priority is a “pull-mode-first” mode giving priority to a pull mode service, stopping a remote control;
if the obtained priority is a “push-mode-first” mode giving priority to a push mode service, transmitting a remote control command to the client and receiving a result of execution of the remote control command from the client;
if the obtained priority is a “user-selection-first” mode in which the service mode is determined by a user selection, transmitting the remote control command to the client, and if the user selection is a “pull mode,” stopping the remote control, and if the user selection is a “push mode,” receiving the result of the execution of the remote control command from the client.

13. A push mode service providing method comprising:
providing from a client a priority in relation to a desired service mode to a server; and
receiving a push mode service or a pull mode service from the server according to the provided priority.

14. The method of claim 13, wherein the providing of the priority comprises:
receiving a request from the server for the priority; and
transmitting the priority from the client to the server in response to the request.

15. The method of claim 13, wherein the receiving of the service comprises:
if the priority is a “pull-mode-first” mode giving priority to the pull mode service, requesting to stop the push mode service; and
if the priority is a “push-mode-first” mode giving priority to the push mode service, requesting to provide the push mode service.

16. The method of claim 14, wherein the receiving of the service comprises:
if the priority is a “pull-mode-first” mode giving priority to the pull mode service, requesting to stop the push mode service; and
if the priority is a “push-mode-first” mode giving priority to the push mode service, requesting the server to provide the push mode service.

17. The method of claim 15, wherein the receiving of the service comprises:
if the priority is a “user-selection-first” mode in which the information providing mode is determined by a user selection, receiving the user selection and then, if the user selection is a “pull mode,” requesting to stop the push mode service, and if the user selection is a “push mode,” requesting to provide the push mode service.

18. The method of claim 16, wherein the receiving of the service comprises:
if the priority is a “user-selection-first” mode in which the information providing mode is determined by a user selection, receiving the user selection and then, if the user selection is a “pull mode,” requesting to stop the push mode service, and if the user selection is a “push mode,” requesting to provide the push mode service.

19. A push mode service providing method comprising:
providing from a client a priority in relation to a service mode selected by a client to a server;
if the priority is a “pull-mode-first” mode giving priority to a pull mode service, requesting to stop a remote control;
if the priority is a “push-mode-first” mode giving priority to a push mode service, executing a remote control command received from the server and transmitting a result of the execution to the server; and
if the priority is a “user-selection-first” mode in which a service mode is determined by a user selection, if the user selection is a “pull mode,” requesting to stop the remote control, and if the user selection is a “push mode,” executing the remote control command received from the server and transmitting the result of the execution to the server.

20. A method of providing information from a server to a client, the method comprising:
requesting priority information from the client;
receiving the priority information from the client in response to the request;
if the priority information indicates a “pull-mode-first” mode giving priority to a pull mode service, providing the pull mode service to the client; and
if the priority information indicates a “push-mode-first” mode giving priority to a push mode service, providing the push mode service to the client.
